(19) United States
(12) Patent Application Publication
(10) Pub. No.: US 2012/0098657 A1
(43) Pub. Date: Apr. 26, 2012

(54) Tracking lane marker position through use of information-transmiting device

(76) Inventor: Oleg Bogatine, Gaithersburg, MD (US)

(21) Appl. No.: 12/925,564

(22) Filed: Oct. 25, 2010

(51) Int. Cl. B60Q 1/00

(52) U.S. Cl. 340/439

(57) ABSTRACT

Detecting position of the vehicle with respect to the lane marker lines through use of information-transmitting devices has been proposed. At least one row of information-transmitting wireless devices is provided for a lane marker line, wherein each of the devices is adapted for transmitting information to a reader usable for detecting the position of the vehicle as it comes in close enough proximity to the wireless device. Each of the devices transmits a digital signal to the reader installed on the body of the vehicle, which contain information of the line styles (dashed, solid etc.), line colors (white, yellow or blue) and locations with respect to the road. The information-transmitting devices may be placed just on the road surface, at some depth of the road surface, on light reflectors, guardrails, traffic cones, or any other devices installed on a road for traffic control or for any other purposes. The information-transmitting devices may be positioned just on or on a side of the marker lines or on the center or in proximity of the center of the traffic lane. The method proposed allows detection of the lane marker line no matter how difficult lightening conditions are and unambiguously determine the nature of the line detected.

References Cited

| | | | |
|---|---|---|---|
| 3,201,750 | August 1962 | Morin | 340/904 |
| 5,245,422 | September 1993 | Borcherts et al. | 358/103 |
| 5,351,044 | September 1994 | Mathur et al. | 340/901 |
| 5,835,028 | November 1998 | Bender et al. | 340/436 |
| 6,930,593 | September 2005 | Crawshaw | 340/435 |

### BACKGROUND OF THE INVENTION

The present invention relates to vehicle position tracking sensor and alarm system to signal driver when vehicle is changing or close to changing the road lane.

One of the reasons of automobile road accidents which practically every driver has experienced while driving for a long time is the feeling of drowsiness or looking away of the direction of travel or any other way of loosing control of the operated vehicle, which makes driver inattentive. It may cause the vehicle to swerve and unintentionally change the lane on a road. This becomes a cause of thousands of accidents every year. The systems, which provide an alarm to alert the driver and other participants of the traffic to avoid such a dangerous situation, are known in prior arts.

U.S. Pat. No. 3,201,750 (Automobile Swerve Alarm System), issued Aug. 17, 1962 to Morin, which is incorporated herein by reference, discloses an automobile alarm system of signaling the operator when he comes dangerously close to left-hand side of the road or lane in which he is traveling. The system suggested has been based on the light-sensitive cell which produces different signal in front of the unmarked road pavement and in front of the dividing line.

The main light-sensitive cell approach disadvantage that it is inaccurate, either insensitive in case of low lighting or too sensitive, or may be triggered by radiation of all kinds such as from passing cars, or radiations from light pavement and the like.

Another approach has been used in solutions where line tracking system have been proposed on the base of modern image processing devices which can monitor the vehicle position by imaging a roadway and detecting lane markers. This category of lane tracking solutions has been presented by U.S. Pat. No. 5,245,422 (System and Method for Automatically Steering a Vehicle within a Lane in a Road) issued Jun. 28, 1991, U.S. Pat. No. 5,351,044 (Vehicle Lane Position Detection System) issued Aug. 12, 1992, U.S. Pat. No. 5,835,028 (Lane Marker Position Sensor and Alarm) issued Nov. 10, 1998, U.S. Pat. No. 6,930,593 (Lane Tracking System Employing Redundant Image Sensing Devices) issued Aug. 16, 2005 that have been incorporated herein by reference.

The main problem for this category of the lane tracking systems is a poor lane imaging under harsh lighting conditions, such as nighttime driving where oncoming headlights can saturate the imaging system making it impossible to detect lane markers illuminated by the vehicle headlights. Another example is bright sunlight where glare off the roadway can saturate the image so the roadway lane markers cannot be accurately detected.

To resolve the limitation of this approach more sophisticated cameras and image processing systems have been proposed to increase the ability of the image system to detect the lane markers despite the poor image quality.

Though image processing solutions become more and more complex and costly they in principal may not be successful in all of the lighting and road conditions which will be experienced in real world applications.

Another problem of the prior arts solution is that even if they detect a lane marker accurately the only limited information may be provided. They can not detect if this is the solid line which is marking the boundary between neighboring, let say second and third, traffic lines of the one direction or the separation line between lanes of opposite directions or just a boundary of the road if lines look the same.

Accordingly the need presently exist for a system and method for detecting lane markers in a roadway irrespective of road or lighting conditions, which provide unambiguous information of the nature of the line detected.

### SUMMARY

The purpose of the present invention is to provide a lane position sensor system, which can accurately detect a lane marker line no matter how difficult lightening conditions are and unambiguously determine what kind of line it is.

The present invention relates generally to information transmitted devices (such as radio frequency identifications, or “RFID”, tags), and more particularly, the use of such devices for detecting the position of the vehicle with respect to the lane markers.

A preferred embodiment of the present invention includes radio frequency identifications tags (RFID tags) attached to the road in a place which allows tracking the position of the vehicle with respect to the lane markers, wherein each of these tags is adopted for transmitting information to a reader mounted on the vehicle. The reader is coupled with a communication processing device which in turn coupled with a user interface equipped with either speaker or visual display or both that have been used to alarm driver (if needed) about the crossing of the lane marker line or threatening of the crossing of the lane markers providing a specific information of the nature of the marker line.

The system offered comprises a stationary part which consists of information transmitted devices (RFID tags for example) installed just on a road, the reader (or readers) installed on a vehicle in place (places) which provides them to be in effective distance to the RFID tags which is enough for the tag to receive sufficient power to enable clocking the semiconductor and analog portions comprising the transponder, control circuits, and data memory through enough clock cycles that the tag can return the data bits from its memory as a digitally-encoded RF signal.

In this way the tag can be read wirelessly from a certain predetermined distance. The reader transmits the signal read from the RFID tag to the third part of the system, which is an user interface equipped with an alarm system which is initiating a sound or visual signal for the event like crossing the lane markers preprogrammed to be reported to driver.

The RFID tags may be attached to the road surface individually or just as a part of the adhesive tape, in which case the application of these tags may be done at the same time as painting the markers lines just by rolling out a roll of adhesive tape down the road.

RFID tags that have been installed on a road near different marker lines may transmit different digital signal by which the system will detect which particular line a vehicle is approaching to or crossing it over. This feature is really advantageous because it allows from one hand to completely avoiding complex and expensive image detecting and processing for image based system, and from other hand does not depend upon hard lightening conditions which are the most frequent cause of fails of the imaging systems.

The particular RF digital signal generated by RFID tag when the vehicle comes close enough to a row of RFID tags will unambiguously detect what kind of marker line is that: a left boundary of the right lane of the road or a right boundary of the left lane or a separation line between lanes of opposite driving direction. Depending of the particular type of the marker line the user interface will generate different sound or visual signals or both if the system has been preprogrammed to alarm a driver about this particular event.

In addition to the information of the position of a tag with respect to the road marking the signal of the transponder may contain information of its geographical location. It should be noted that such universal information like global positioning coordinates themselves, providing by GPS, is still useless for our purpose as it does not provide information of the position of the vehicle with respect to the road marking.

The foregoing summary is illustrative only and is not intended to be in any way limiting. Other aspects, inventive features and advantages of the present invention will become apparent in the non-limiting detailed description set forth below.

### BRIEF DESCRIPTION OF THE DRAWINGS

FIG. 1 illustrates a typical design of RFID tags, according to the prior art.

FIG. 2 illustrates a sample positioning of RFID tags installed at the center of the solid marker line.

FIG. 3 illustrates another configuration of the RFID tags on a road when 2 rows of tags have been installed from both sides of the marking line.

FIG. 4 illustrates possible positions of the RFID reader on a vehicle.

FIG. 5 illustrates a simplified block diagram for a system in accordance with a preferred embodiment of the present invention.

### DETAILED DESCRIPTION OF THE PREFERRED EMBODIMENT

Embodiments of the present invention enable detection of the position of vehicles using information-transmitting devices installed on a road in certain order with respect to the road marking. One example of this kind of devices is RFID tags.

The tags may be placed in proximity or just directly on the marking line which they suppose to detect when the vehicle is either approaching or crossing such a line. Such a tag may be installed individually in which case it has been presented most often as a polymer label-like base with a tag on it. The simple way to attach this label to the road surface is just to spray an adhesive to one side of the label and apply the label with an adhesive side to the road surface.

As another alternative the RFID tags may be attached to the tape with an adhesive surface and applied to the road by rolling out the tape roll down the road. There is a variety of applicators of all kinds in industry which are performing this simple operation. The advantage of this method is that the application of the tags in this case may be done at the same time as a painting of the road marking lines. For this purpose the painting machine should be equipped with an applicator which will apply the tape right after, in parallel or before the line painting.

As another alternative the RFID tags may be installed before the final layer of the road pavement (asphalt or concrete) has been applied at the time of the construction or repair of the road. In this case RFID tags are located at some depth below the road surface. The advantage of this installation is that RFID tags become insensitive to mechanical damages on a road surface.

As another alternative the RFID tags may be printed for instance using conductive adhesive inks just on a road surface.

As another alternative the RFID tags may be installed or just printed or incorporated by any other way on the traffic light reflectors installed to make a traffic marking lines visible at the night time.

As another alternative the RFID tags may be installed on the guardrails, barriers, separating lanes of the road with an opposite directions, balustrades or any other devices guarding edges of the roads.

And as still another alternative the RFID tags may be attached or incorporated by any other way to the traffic cones, traffic control barriers, channelizers, barricades, traffic drums, traffic delineators, traffic posts or any other devices installed on a road for traffic control or for any other purposes.

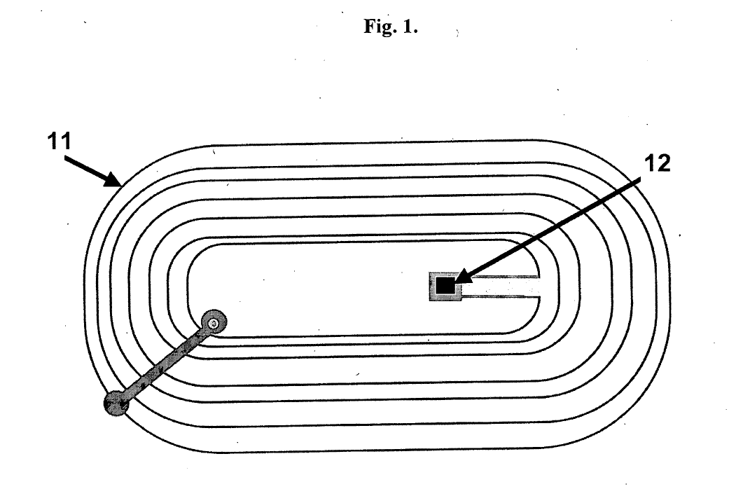

The RFID tag consists of the antenna 11 and semiconductor chip 12, illustrated on FIG. 1. As RFID chips now getting as small as thickness of a man hear, the size of the tag has been determined by the size of antenna. The typical antenna sizes for today's RFID tags are 2-4 in. With a distance between tags of 6-8 in, which should serve quite sufficient for the purpose of invention, the number of tags needed comes to 3 tags per yard. With a price of tag, which is a few (5-7) cents per tag, the cost for one mile of the tag's row has been starting from $260/mile, which is a negligible component of the road cost.

The data memory of the typical RFID chip today has a capacity up to 256 bytes. This memory used to store an “Electronic Product Code” or “EPC”, a counterpart of the bar code that assigns a searchable number to each inventory item. The EPC uniquely identifies an item individually and the present version of the code uses 96 bits of information, which is enough to uniquely identify trillions of items. This is far more then enough to cover any possible situations of vehicle's position with respect to the road marking lines.

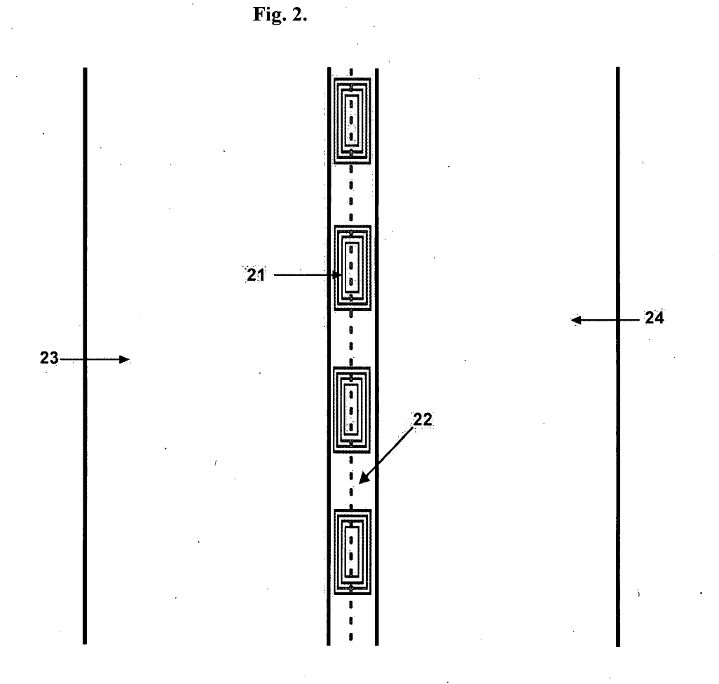

The positioning of RFID tags with respect to the road marking lines may be different depending upon specific road and system requirements. FIG. 2 illustrates an example when the row of RFID tags 21 has been installed just at the center of the solid marking line 22, separating two traffic lanes 23 & 24.

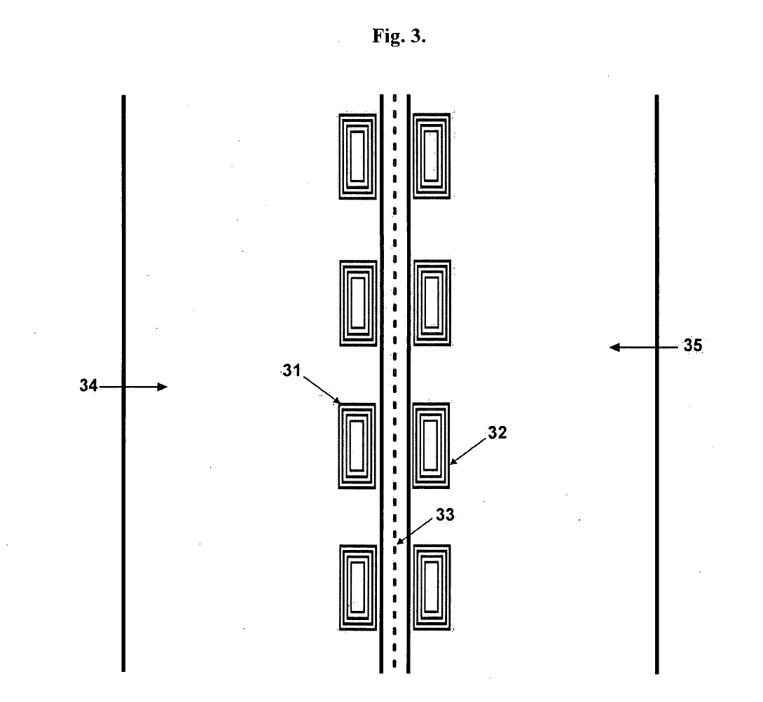

As another alternative of the positioning of the RFID tags they may be placed as shown on FIG. 3 on sides of the marking line 33. In this case there are 2 rows of tags 31 & 32 located on both sides of the marking line 33, separating two traffic lanes 34 & 35. It is convenient if you want to clearly distinct an event of the approaching of the vehicle to the marking line and an event of the crossing of the line.

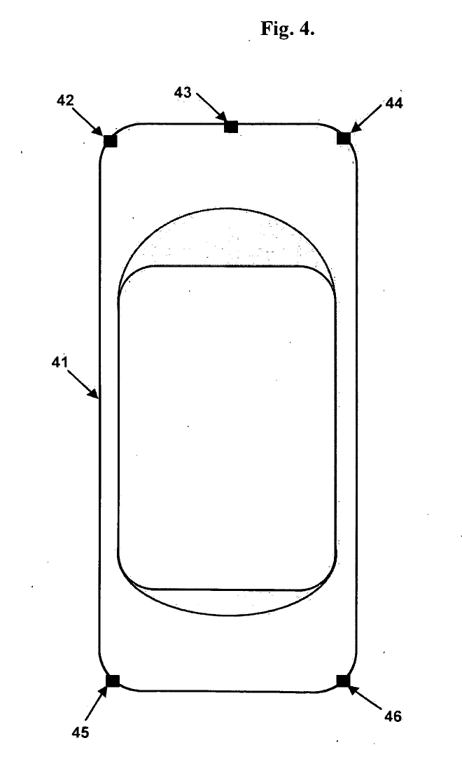

The positioning of reader(s) on a car may also be different. The FIG. 4 demonstrates possible locations of the readers 42, 43, 44, 45 and 46 on a body of the car 41. It is naturally to install reader as close as it possible to the front corners of the car as in a regular driving they will cross marking line first. It is also pretty useful information to know when the vehicle is crossing this line completely and, in so doing, has completely changed a road lane. For these purpose the readers should be located as close as it possible to the back corners of the vehicle which are the final points of the vehicle, leaving the lane.

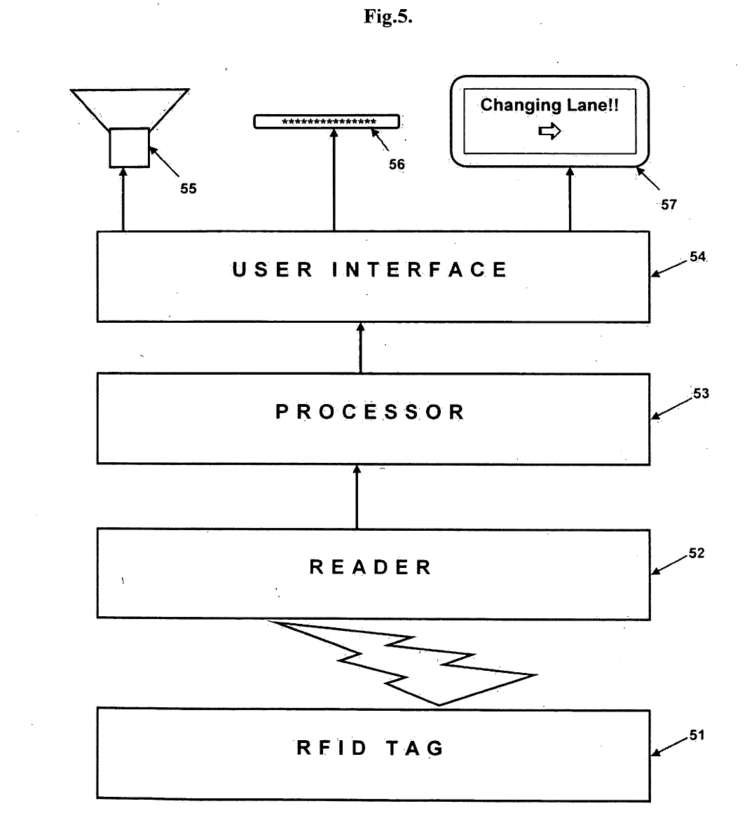

FIG. 5 shows a simplified representation of the system, in accordance with a present invention. The RFID Reader 51 is coupled with a processor (communication device) 52. The processor is coupled with user interface 53, which can include a speaker 54, text display 55 or any other display 56 or all together. This is a dynamic part of the system that has been installed on a vehicle and accordingly changing its position with respect to the road marking system with a moving vehicle. The rows of RFID tags installed on a road comprise a stationary part of the system, which does not change its position.

The RFID reader 52 (or readers) has been installed on a vehicle and adjusted in a way to activate the RFID tag 51 on a road if it comes closer then a preprogrammed distance to the reader and accordingly to the vehicle. Once the tag 51 occurs in close enough proximity to the vehicle, radio waves, generated by the reader 52, are activating the antenna 11 of the tag 51, which activates in turn a RFID chip 12, which in response produces a digital signal with a preprogrammed number or numbers. This signal has been transmitted through the same RFID tag's antenna 11 back to the reader 52. The reader is continuously monitoring the road and once it receives a signal from the tag transmits the signal to the processor 53 of the user interface 54. If the processor 53 determines a situation to be reported to the driver, it will direct a user interface device 53 to warn a user of the vehicle with a preprogrammed alarm for this particular situation. This may be a sound alarm 55, or a text message on a display 56, or just a blinking light, or some picture/animation on a visual screen 57 or any of their combinations.

The invention claimed is:

1. A method of'tracking vehicle position with respect to road marking lines through use of information-transmitting devices, comprising:
providing at least one information-transmitting wireless device such as, but not limited to RFID tags, installed on a road surface, wherein each of the devices is adapted for transmitting information to a reader, which has been installed on a vehicle such that once the information-transmitting device falls in the predetermined proximity to the vehicle it becomes to be activated and starts to transmit RF signal to the reader.

2. The method according to claim 1, further comprising the step of the placing information-transmitting devices to a road, when each of the device has been attached to or just under the road marking line.

3. The method according to claim 1, further comprising the step of the placing information-transmitting devices to a road, when each of the device has been attached to the or just under a road marking line and producing a unique digital signal in response to the radio waves, generated by the reader, for each combination of the line styles (dashed, solid, doubled etc), line colors (white, yellow or blue) and locations.

4. The method according to claim 1, further comprising the step of the placing information-transmitting devices to a road, when each of the device has been attached on a side of the road marking line and producing a unique digital signal in response to the radio waves, generated by reader, for each combination of the line styles (dashed, solid etc), line colors (white, yellow or blue) and locations with respect to the road (i.e. the left boundary line of the second lane of the I-95 road of the north direction) and location with respect to the vehicle (i.e. the right side of the white dashed left boundary line of the second lane of the I-95 road of the north direction). The sequence of the signals of the devices that have been installed from both sides of the road marking line is going to identify which particular movement (i.e. from the left lane to the right lane) a vehicle is going to undertake. The advantage of this method of the placing of the information-transmitting devices to a road is that in this case we may limit the number of the readers installed on a vehicle with just one reader.

5. The method according to claim 1, further comprising the step of the placing information-transmitting devices to a road, when each of the device has been attached to the or just under or in proximity of the center of the traffic lane, producing a unique digital signal when vehicle is staying inside the lane and stops to produce the signal when vehicle is leaving the lane.

6. The method according to claim 1, further comprising the step of the placing information-transmitting devices to a road, when each of the device has been installed at some depth beneath the road surface.

7. The method according to claim 1, further comprising the step of the placing information-transmitting devices to a road, when each of the device has been attached to the tape with an adhesive surface and applied to the road by rolling out the tape roll down the road.

8. The method according to claim 1, further comprising the step of the placing information-transmitting devices to a road, when each of the device has been attached to the tape with an adhesive surface and applied to the road individually by detaching it out of the tape and applying each of the device down to the road.

9. The method according to claim 1, further comprising the step of the placing information-transmitting devices to a road, when each of the device has been printed on the road using a conductive adhesive suitable to form an antenna on a road surface.

10. The method according to claim 1, further comprising the step of the placing information-transmitting devices to a road, when each of the devices has been attached or incorporated by any other way to the traffic light reflectors installed to make a traffic marking lines visible at the night time.

11. The method according to claim 1, further comprising the step of the placing information-transmitting devices to a road, when each of the device has been attached or incorporated by any other way to the guardrails, barriers, separating lanes of the road with an opposite directions, balustrades or any other devices guarding edges of the roads.

12. The method according to claim 1, further comprising the step of the placing information-transmitting devices to a road, when each of the device has been attached or incorporated by any other way to the traffic cones, traffic control barriers, channelizers, barricades, traffic drums, traffic delineators, traffic posts or any other devices installed on a road for traffic control or for any other purposes.

13. A lane departure warning system adapted for use with a vehicle, comprising:
a. either one or few readers installed on a vehicle
b. a processor receiving a digital signal from the reader(s) which determines if a situation to be reported to the driver and, if so, the way it has to be reported.
c. a user interface that can include a speaker, text display, warning light or visual display or any of their combinations.

14. A lane departure warning system as set up in claim 12 with a user interface which includes a sound warning device producing a specific sound (for instance imitating a sound of the audible rumbling of the vehicle crossing a rumble strip) when vehicle is approaching or crossing a shoulder line or the centerline of the road and generating other sounds when vehicle is approaching to internal lines.

15. A lane departure warning system as set up in claim 12 with a user interface which includes a visual warning device generating specific warning visual signal or picture different for different road situations.

16. A lane departure warning system as set up in claim 12 with a user interface which includes a textual warning interface generating specific text different for different road situations.

17. A lane departure warning system as set up in claim 12 with a user interface which generates a warning signal as a response to the event of the changing of the traffic lane by a vehicle only if a driver did not show the turn signal for the corresponding change.
